(19) United States
(12) Patent Application Publication
(10) Pub. No.: US 2010/0121776 A1
(43) Pub. Date: May 13, 2010

(54) PERFORMANCE MONITORING SYSTEM

(76) Inventor: Peter Stenger, Pleasant Ridge, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/614,616

(22) Filed: Nov. 9, 2009

Related U.S. Application Data
(60) Provisional application No. 61/112,399, filed on Nov. 7, 2008.

(51) Int. Cl. G06Q 10/00

(52) U.S. Cl. 705/347

(57) ABSTRACT

A method of evaluating performance data assigns a weight to each of a plurality of key performance indicators (“KPIs”). Each KPI having an associated bin and corresponding to a portion of a bin score. A weight is assigned to each bin, and each bin corresponds to a scorecard and corresponds to a predefined portion of an overall score. Received performance data is compared to each KPI in at least one selected bin to determine a score for each KPI in the at least one selected bin. An overall score is dynamically calculated on a server in response to the at least one selected bin, in response to the assigned weight of the at least one selected bin and the assigned weights of its corresponding KPIs, and in response to the scores for the selection of KPIs. A scorecard including at least the overall score is transmitted to a user.

### BACKGROUND OF THE INVENTION

The application claims priority to U.S. Provisional Application No. 61/112,399 which was filed on Nov. 7, 2008.

The application relates to monitoring performance data, and more particularly to a system for collecting and presenting performance data.

Systems exist whereby a number of first parties can provide performance data, the system can analyze the performance of the first parties, and a second party can view the analyzed performance data. However, these systems have high implementation costs, as they require extensive customization for each customer, and any modifications require detailed knowledge of programming or scripting.

### SUMMARY OF THE INVENTION

A method of evaluating performance data assigns a weight to each of a plurality of key performance indicators (“KPIs”). Each KPI having an associated bin and corresponding to a portion of a bin score. A weight is assigned to each bin, and each bin corresponds to a scorecard and corresponds to a predefined portion of an overall score. Received performance data is compared to each KPI in at least one selected bin to determine a score for each KPI in the at least one selected bin. An overall score is dynamically calculated on a server in response to the at least one selected bin, in response to the assigned weight of the at least one selected bin and the assigned weights of its corresponding KPIs, and in response to the scores for the selection of KPIs. A scorecard including at least the overall score is transmitted to a user.

A computer-implemented performance monitoring system includes an input/output module, a storage module, and a central processing unit. The input/output module is operable to receive performance data from at least one entity. The storage module is operable to store the performance data, and is operable to store a plurality of key performance indicators (“KPIs”), each KPI having an associated bin and having a weight corresponding to a portion of a bin score. Each bin has a weight corresponding to a portion of an overall score. The central processing unit is operable to process the performance data and to compare the performance data to at least one KPI to determine a KPI score, a bin score, and an overall score in response to a bin selection and an entity selection. A scorecard illustrating scores for the selected bins of KPIs compares the scores for each entity in the entity selection.

These and other features of the present invention can be best understood from the following specification and drawings, the following of which is a brief description.

### BRIEF DESCRIPTION OF THE DRAWINGS

FIG. 1 schematically illustrates a performance monitoring system.

FIG. 2 schematically illustrates a method of evaluating performance data in the system of FIG. 1.

FIG. 3 schematically illustrates a method of walkup registration for a user of the system of FIG. 1.

FIG. 4a schematically illustrates a first portion of example scorecards, example security options, and example roles in the system of FIG. 1.

FIG. 4b schematically illustrates a second portion of FIG. 4a.

FIG. 5 schematically illustrates an example segment scorecard in the system of FIG. 1.

### DETAILED DESCRIPTION

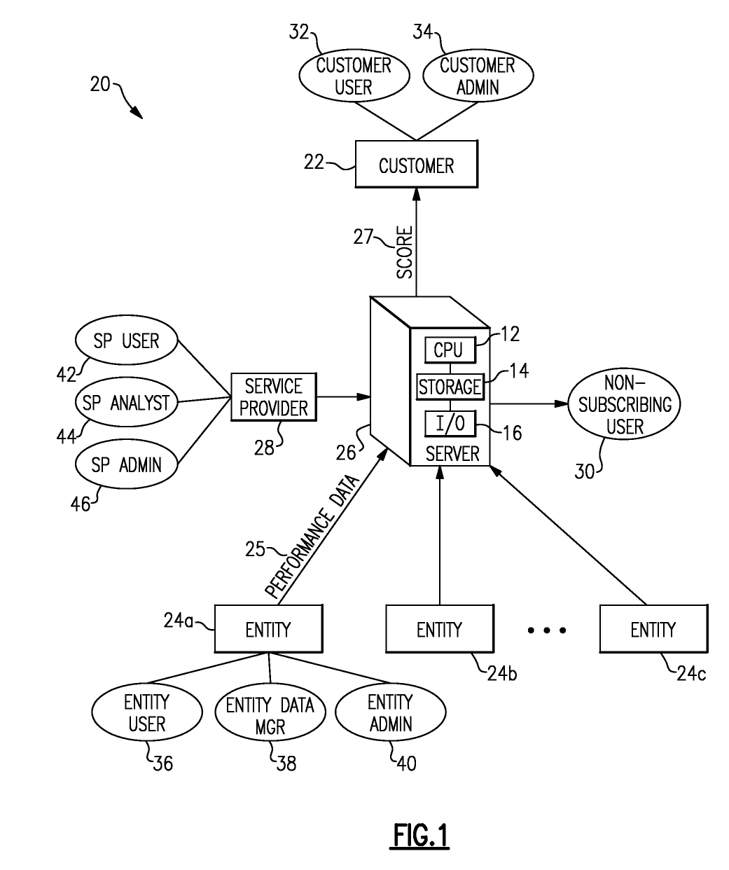

FIG. 1 schematically illustrates a performance monitoring system 20 that includes a customer 22 and a plurality of entities 24a-c, a service provider 28, and a non-subscribing user 30. In this application, the term “users” refers to anyone who uses the system 20. Thus, users could include any one of customer users 32, customer administrators 34, entity users 36, entity data managers 38, entity administrators 40, service provider users 42, service provider analysts 44, and service provider administrators 46. Although FIG. 1 only illustrates one customer 22, three entities 24, one service provider 28, and one non-subscribing user 30, it is understood that other quantities of these users could be using the system 20.

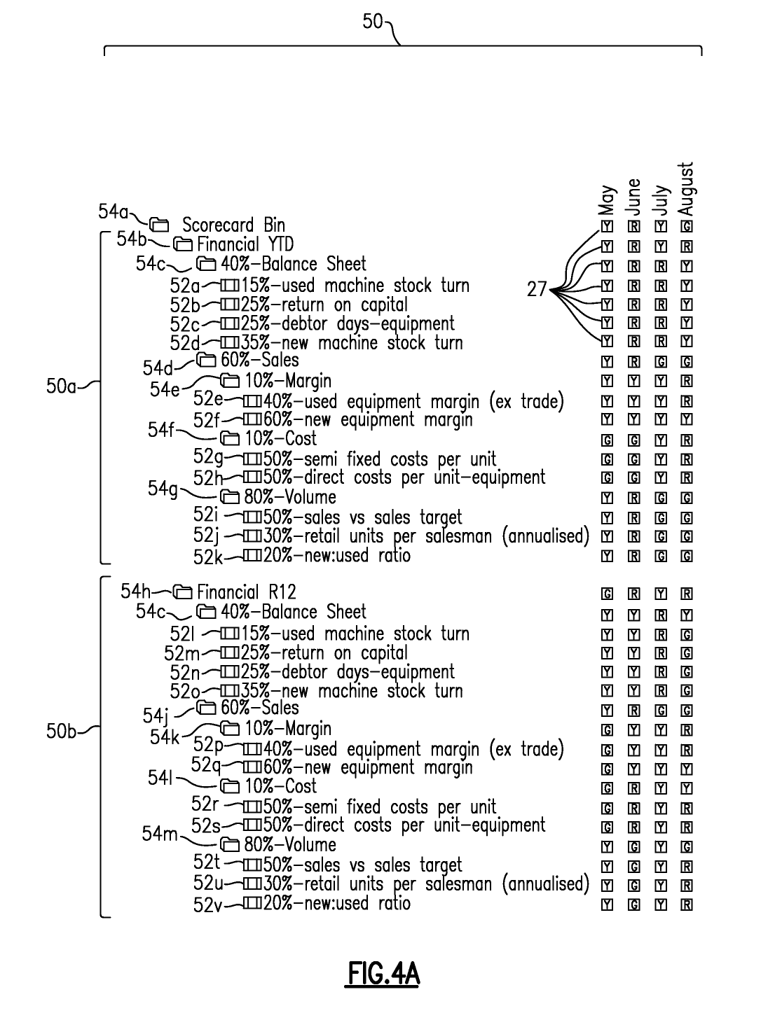

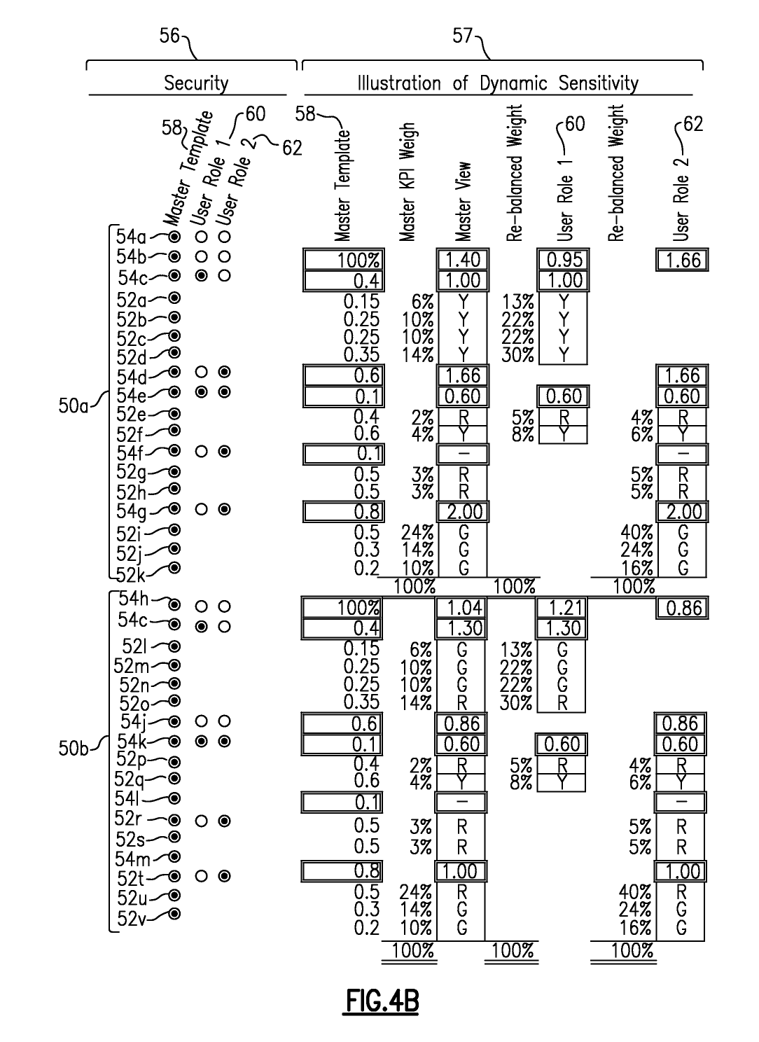

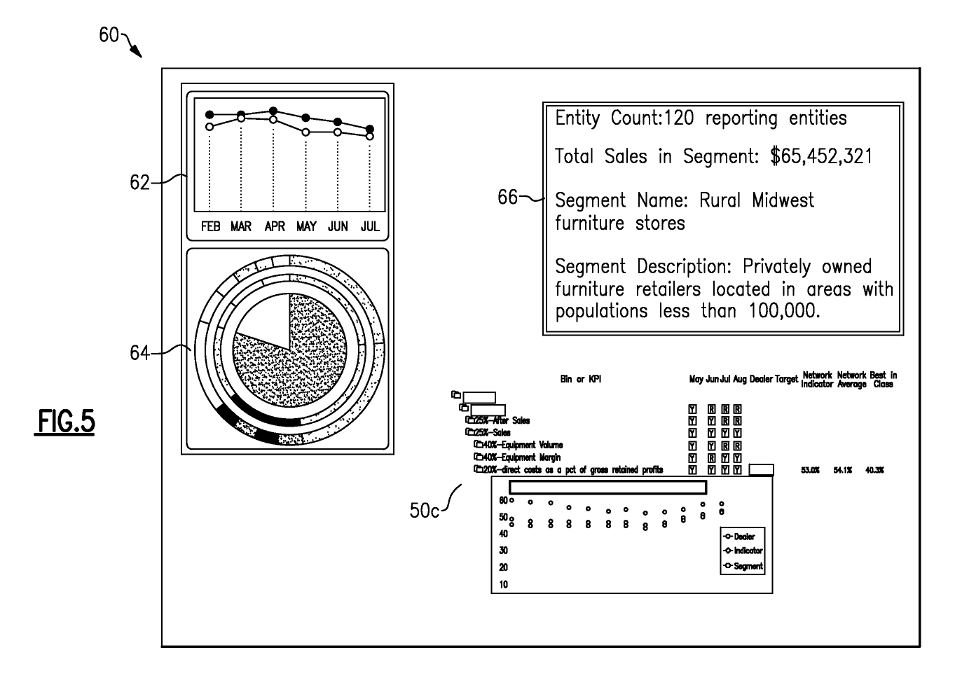

In the system 20, entities 24a-c submit performance data 25 to a server 26. The server 26 processes the performance data 25 by comparing the performance data 25 to a plurality of key performance indicators (“KPI's”) (see FIGS. 4a-b) to determine a score 27. The server 26 transmits the score to a customer 22, optionally as part of a scorecard (see FIG. 5). The server 26 includes a central processing unit (“CPU”) 12, storage 14, and an input/output module 16. The storage 14 may include a hard drive, a flash drive, an optical drive, or any other storage medium The input/output module 16 facilitates reception and transmission of data (e.g. performance data). The storage 14 may include a database to store performance data 25, for example. While the server 26 may be a web server, it is understood that other types of servers could be used. It is understood that the server 26 could include hardware, software, and firmware individually or in various combinations.

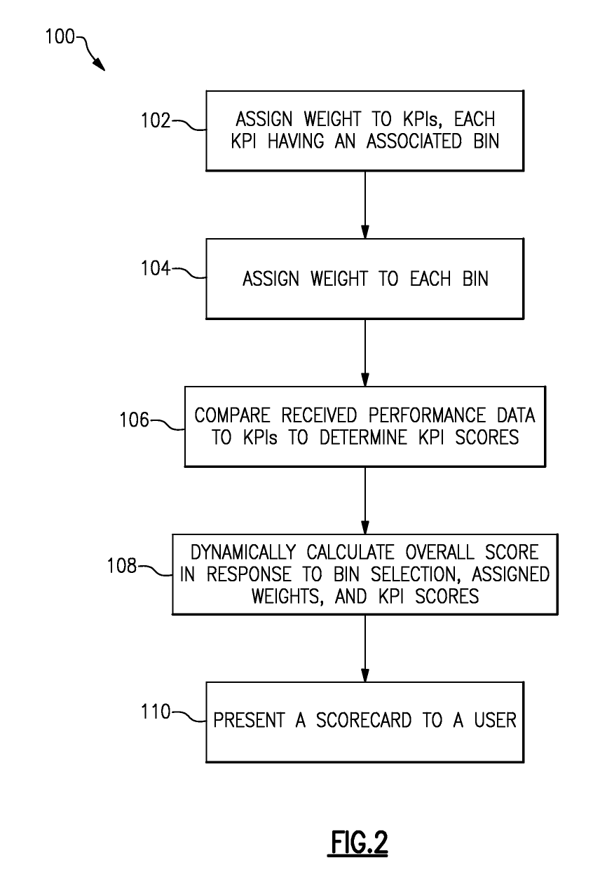

FIG. 2 schematically illustrates a method 100 of evaluating performance data 25 in the system 20. A weight is assigned to each KPI and to each collection of KPI's, also known as “bins” (step 102). FIGS. 4a-b illustrate a plurality of KPIs 52a-v organized into a plurality of bins 54a-m. Using the example of bin 54c and KPIs 52a-d, KPI 52a has a weight of 15%, KPI 52b has a weight of 25%, KPI 52c has a weight of 25%, and KPI 52d has a weight of 35% such that the weights of KPIs 52a-d add up to 100%.

A weight is assigned to each bin 54 (step 104). Referring again to bin 54c also has a weight of 40% which corresponds to a portion of the score of parent bin 54b. Multiple bins can be nested (see, e.g., bins 54a-c) and the bins can be scored separately. An ultimate parent bin (see, e.g. bins 54a, 54h) are “scorecard” bins used to create a scorecard (see FIG. 5).

Referring again to FIG. 1, performance data 25 is received from the entities 24, and the performance data is compared to KPIs 52 to determine KPI scores (step 106). An overall, “scorecard” score is calculated in response to a selection of bins 54, assigned weights to the bins 54 and KPIs 52, and in response to the KPI scores (step 108). This score 27 is transmitted to a user, such as the customer 22, in the form of a scorecard (step 110).

Each of these features will be discussed in greater detail below.

System Applications

The system 20 is widely applicable to any situation where it is desirable to view performance data of an entity 24, or to compare performance data for a plurality of entities 24a-c. One example application is that of a sales system. In this example, the customer 22 could be a car company, the entities 24a-c could be car dealerships, the performance data 25 could correspond to dealership sales data, and the score 27 could rate the performance of the sales of each car dealership.

Another application for the system 20 is a supply chain. The customer 22 could be an original equipment manufacturer (“OEM”), the entities 24a-c could be suppliers, the performance data could correspond to deadlines and budgets, and the score 27 could correspond to the degree to which the suppliers met the deadlines and stayed within the budgets.

Another application for the system 20 is school districts. In this example, the customer 22 could be a school district, the entities 24a-c could be individual schools within the school district, and the performance data 25 could correspond to areas such as student test scores, teacher satisfaction, teacher salaries, etc. The score 27 could rate these areas according to a plurality of KPIs. For example one KPI could compare student test scores in one school to student test score in all other schools in the system 20. Another KPI could compare teacher salaries to that of a national average, or a school district average.

Another application for the system 20 is accounts receivable credit management. In this example, the customer 22 could be a business that extends credit, and the entities 24a-c could be groups that obtain credit from the business. The performance data 25 could correspond to sales of each of the businesses. The score 27 could monitor the performance of departments or locations within one business enterprise, or within a portfolio of businesses. The score 27 could be used to drill down to underlying data to identify problem areas. In this example, the customer 22 could make participation in the system 20 a pre-condition before any of the business entities 24a-c could obtain credit.

Another application for the system 20 is a trade association. In this example, the customer 22 could be the trade association, and the entities 24a-c could be members of the trade association. A plurality of scores 27 could be organized into a scorecard to allow the members to obtain dashboard views of their operations and to benchmark their performance data against a comparative peer group.

Registration

The system 20 enables registration for customers 22 and entities 24 and facilitates association between customers 22 with and 24 in a variety of ways. An entity 24 can register with the system 26 by either registering unilaterally (“walkup registration”), by responding to an invitation to register, by being registered by a related entity (such as a parent entity), or by having the service provider 28 register the entity 24.

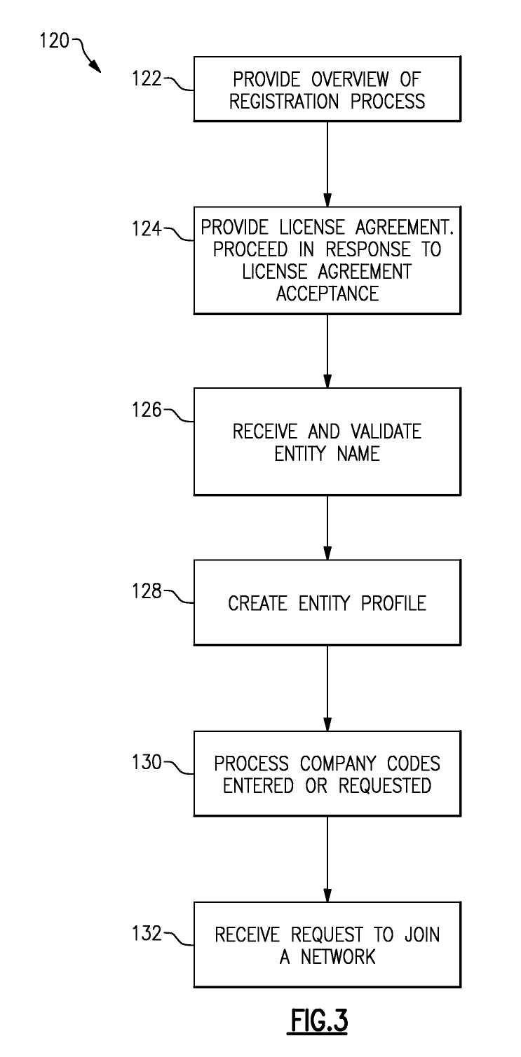

FIG. 3 schematically illustrates a method 120 of walkup registration for an entity 24 in the system of FIG. 1. The system 20 provides an overview of the registration process to the entity 24 (step 122). Step 122 could include a “Captcha” style validation to verify that an actual person is trying to register in the system 20, and that a bot was not trying to create a spam account in the system 20. Step 122 could also include a detailed description of the registration process 120, and could provide an itemized list of required information to complete the registration process 120. Step 122 could also provide an opportunity for an entity 24 to download a portable Document Format (“PDF”) document containing startup registration information.

A license agreement is displayed, and may be accepted or rejected (step 124). In one example the system 20 only proceeds with registration if the license agreement is accepted. An entity name is received and validated (step 126) to ensure that two entities do not use the same entity name, and to ensure that a single entity does not create multiple duplicative accounts. Step 126 may include an “Entity Name Explorer” that can indicate whether a duplicate name exists, can suggest alternate entity names, and can list potential matches to allow a registering entity 24 to send a note to the service provider 28 to request access to an existing entity.

An entity profile is created (step 128). In one example the entity profile includes a company name, division, address, contact name, contact email, a Data Universal Numbering System (“DUNS”) number, and stock market symbol for publicly traded companies. Step 128 may also include creating an additional profile for an entity user 36, an entity data manager 38, or an entity administrator 40 (see FIG. 1). The additional profile corresponds to an individual associated with the entity, such as an employee of the entity or a consultant working with the entity. In one example the additional profile includes a user email address, first and last name, title, and address. In one example a person creating a entity is given all three entity authority levels: entity administrator, data manager, and entity user.

An entity 24 may enter company codes, or may request company codes to initiate an association with a certain company customer 22 (step 130). In one example step 130 includes assigning a unique code to the entity 24 being registered. The entity being registered may also request to join a network (step 132). For example, an automotive supplier entity could request to join a network of other automotive supplier entities.

By providing the walkup registration process 120, the system 20 is readily scalable and facilitates cost-effective registration of both entities 24 and customers 22 so that the system 20 can be economically expanded without requiring extensive customization.

Also, as discussed above, although FIG. 3 schematically illustrates a walkup registration process, it is understood that an entity 24 can also register with the system 26 by responding to an invitation to register, by being registered by a related entity, or by having the service provider 28 register the entity 24. In one example, a company having multiple divisions could register itself as an entity 24, and could then register its individual divisions as entities also without requiring action on the part of the individual divisions.

Handshake Process

The system 20 is operable to associate customers 22 and entities 24 is through a handshake process so that the customers 22 can view performance data 25 from the entities 24. The handshake process includes the sending of a unique alphanumeric token, the acceptance or rejection of that token, and the formation of an association in response to an acceptance of the token. The token may be transmitted electronically (e.g. via email) or manually (e.g. via U.S. Postal Service).

Handshakes can occur one at a time, or in bulk. For example, if the customer 22 is an automotive OEM company, and the entities 24a-c are suppliers, the automotive OEM customer 22 could invite a single supplier entity 24 to join the system 20, or could invite a plurality of supplier entities 24a-c simultaneously. Each entity 24 could then accept the token, completing the handshake process so that the OEM customer 22 and the accepting supplier entity 24 are associated with each other in the system 20. Each entity 24 could also reject the token, preventing an association from happening between the inviting OEM customer 22 and the rejecting supplier entity 24.

Entities 24 can similarly send tokens to customers 22. To continue the example from above, if the supplier entity 24 wanted to commence a business relationship with the automotive OEM customer 22, the supplier could send a token to the OEM customer 22. The automotive OEM customer 22 could then accept the token and begin receiving performance data 25 from the supplier entity 24, or could reject the token and choose not to receive performance data 25 from the supplier entity 24.

In some instances it is more appropriate to allow a customer 22 to unilaterally associate themselves with entities 24. For example, if a large company customer 22 had many offices all over the world, and the large company customer 22 wanted to grant those offices access to the system 20 as entities 24 to view performance data of various branches or divisions of the large company customer 22, the large company customer could unilaterally add the offices to the system as entities 24, bypassing the handshake process.

Obtaining and Analyzing Performance Data

As described above, performance data 25 on the server 26 is received from entities 24. To upload performance data 25, an entity 24 could fill out a web-based form, or the entity 24 could upload a document, such as a spreadsheet, that the server 26 could parse to obtain performance data 25. In one example, the entity 24 could contact the service provider 28 to obtain assistance uploading performance data 25.

The server 26 compares the performance data 25 to at least one predefined KPI 52 to determine at least one score 27 (step 106) that may be presented along with other scores in a scorecard 50. FIGS. 4a-b schematically illustrate a first example scorecard 50a and a second example scorecard 50b in the system 20 of FIG. 1. Each scorecard 50a-b includes a plurality of KPIs 52a-v that may be organized into a plurality of folders, or “bins” 54a-m. The first bin 54a is a scorecard bin that includes the first and second scorecards 50a-b. The first scorecard 50a includes the “Financial YTD” bin 54b, and the second scorecard 50b includes the “Financial R12” bin 54h. The scorecards 50a-b are scored separately.

The KPIs 52 and bins 54 are each separately weighted. For example, in the “Financial YTD” bin 54b of scorecard 50a, 40% of the score corresponds to balance sheet (bin 54c) and the remaining 60% corresponds to sales (bin 54d), for a total of 100%. The balance sheet bin 54c includes the following KPIs each having an associated weight: “used machine stock turn” 52a (15% weight), “return on capital” 52b (25% weight), “debtor days—equipment” 52c (25% weight), and “new machines stock turn” 52d (35% weight).

In the example of FIGS. 4a-b, each KPI 52 is assigned a score to indicate the degree to which the KPI was accomplished or achieved. In one example, a score may be assigned a color to indicate score, for example: green (excellent), yellow (satisfactory) or red (unsatisfactory). As shown in FIGS. 4a-b, the “used machine stock turn” KPI 52a has a yellow (satisfactory) score for May and June, a red (unsatisfactory) score for July, and a yellow (satisfactory) score for August. In one example scores of green, yellow, and red have corresponding numeric scores of “2” “1” and “0” respectively. Of course, other colors, score classifications, and score values could be used.

Roles and Groups

Since different users may need to monitor different KPIs 52, roles can be assigned to different groups of users. Groups are collections of users with specific access rights to each scorecard 50.

Users may be arranged into groups based on their role, such that each member of a group is assigned a particular role (see, e.g., roles 60, 62). For example, if it is desirable for a customer user 32 to only have access to limited portions of performance data for an entity 24, then a the customer user 32 could be assigned to a role that would only enable to see KPIs corresponding to the performance data they are permitted to view. Similarly, if it is desirable for a customer admin 34 to be able to view all performance data for the entity 24, a customer admin role could be created granting customer admins 34 appropriate access to all KPIs.

For example, an automotive dealership customer 22 may have a new car sales department entity 24, a used car sales department entity 24, and a service department entity 24. A sales manager may need to monitor the new and used car sales department entities, but would not care about (or need to see) the service department performance data, so a “sales” role could be created for the new car sales manager. Similarly, a service manager may need to monitor the service department, but would not care about (or need to see) the sales department performance data, so a “service” role could be created for the service manager. An “owner” role could also be created for an owner of the automotive dealership customer 22 who needs to view performance data of new car sales, used car sales, and service.

Dynamic Reweighting

FIGS. 4a-b schematically illustrate a set of security options 56 that include a master template 58, a first user role 60 and a second user role 62. The roles 60, 62 each correspond to groups of users (as described above). The master template 58 includes every KPI 52a-v. The first user role 60 includes KPIs in bins 54c, 54e, 54i, and 54k. The second user role 62 includes KPIs in bins 54d (which includes bins 54e-g) and bins 54k, 54l, and 54m. Because the first user role 60 and the second user role 62 does not include some KPIs, the system 20 dynamically reweights the remaining KPIs to add up to 100% for each scorecard 50a-b. For example, KPI 52e is assigned an initial weight of 2% in the master template 58, is assigned a weight of 5% for the first user role 60, and is assigned a weight of 4% for the second user role 62. The KPI 52e is thus re-weighted for the user roles 60, 62. The initial weights may be adjusted using a set of administrative options 58. Thus, if a customer 22 did not want to accept a dynamic re-weighting performed by the server 26, the customer 22 could access the administrative options 58 to manually change the weights assigned to various KPIs 52.

As another example, bin 54f is worth 10% in the sales bin 54d in the master template 58. Bin 54f includes KPIs 52g and 52h, each equally valued at 50%. The sale bin 54d is worth 60% of the first scorecard 50a. Thus, the KPIs 52g-h are each worth 3% (10%×50%×60%) of the scorecard 50a. However, if a user group only had access to bin 54e and nothing else, then the KPIs 52g-h would each be worth 50% to that user group.

Although, although FIGS. 4a-b are shown as only having entire bins selected or deselected.

User Groups

As shown above in FIG. 1, customers 22, entities 24, a service provider 28, and non-subscribing users 30 may access the system 20. Each of those groups will now be discussed in greater detail.

1) Customers

Customers 22 may include customer users 32 and customer administrators (“admins”) 34. A customer user 32 has permission to access performance data and scorecards, but cannot perform other functions, such as accepting or rejecting tokens from entities 24. A customer admin 34 has greater permission than a customer user 32, and may perform administrative functions such as creating and modifying accounts of customer users 32, accepting or rejecting tokens from entities 26, modifying scorecards, creating KPIs, etc.

2) Entities

Entities 24 may include entity users 36, entity data mangers 38, and entity administrators (“admins”) 40. Entity users 36 have limited permissions in the system 20, and may only perform limited tasks, such as viewing entity scorecards. Entity data mangers 38 have additional permissions, and can perform additional tasks, such as uploading performance data. Entity admins 40 have even greater permissions, and may perform additional tasks, such as adding and editing accounts of entity data managers 38 and entity users 36.

3) Service Provider

The service provider 28 may access the server 28 to perform functions such as modifying KPIs, accessing accounts of customers 22 or entities 24a-c, and facilitating performance data uploads. Each customer 22 is identified by a unique customer code, and each entity 24 is identified by a unique entity code.

The service provider 28 may require the customer 22 and entities 24 to pay a subscription fee to access the system 20. In one example customers 22 pay a first subscription rate, entities pay a second subscription rate that is less than the first subscription rate, and the service provider 28 and non-subscribing user 30 does not pay a subscription rate. Of course, other fee arrangements would be possible.

The service provider 28 may include service provider users 42, service provider analysts 44, and service provider administrators (“admins”) 46. Service provider users 42 could be employees of the service provider 28 who have limited permissions in the system 20 and can only perform tasks such as searching for entities 24, displaying entity scorecards in a read-only view, and displaying entity customer templates in a read-only view.

Service provider analysts 44 have additional permissions, such as creating entities; creating customers; uploading entity financial data; modifying scorecards, segments and templates; displaying entity scorecards; and displaying customer templates. Service provider admins 46 have even more permissions, such as creating or modifying accounts of service provider analysts 42 and users 44.

4) Non-subscribing Users

Non-subscribing users 30 are not customers 22, entities, 24 or service providers 28. Non-subscribing users 30 are third party groups or individuals who have limited access to the system 20. Non-subscribing users 30 cannot define scorecards 50 or upload performance data 25, but they can, for example, have access to ad-supported functionality as described below in the “Marketing” section.

Segments

A segment is a defined group of entities 24. A segment may also include a selection of KPIs 52 and bins 54 for the defined group of entities. Segments may be defined to group together entities that share a common characteristic. For example, a segment could be defined to include entities within a geographic region, such as “all suppliers in Michigan” or “all rural dealers in the Midwest.” Segments provide a way for a customer 22 to create a peer group for benchmarking.

Segments can be useful because there may be many entities 24 associated with a single customer 22. For example, an automotive OEM customer 22 could create a first segment for all of its tooling supplier entities 24 with revenue greater than $100 million, and could create a second segment for all of its tooling supplier entities 24 with revenue less than $100 million.

As an additional example, an educational customer 22, such as the Michigan Board of Education, could create a first segment for all grade schools in Southeast Michigan, could create a second segment for all grade schools in Western Michigan, and could create a third segment for all high schools in Michigan.

In one example an entity 24 is placed in a default segment based upon the entity's North American Industry Classification System (“NAICS”) code.

FIG. 5 schematically illustrates a segment scorecard 60 that includes graphs 62 and 64 of performance data 25, a performance summary 66, and a scorecard 50c.

Privacy

Since an entity 24 may be uploading confidential or sensitive performance data 25 the entity 24 may not want the customer 22 to see their performance data 25 in its full detail. Therefore, an entity 24 can choose what level of data the entity 24 wants the customer 22 to see.

For example, an automotive supplier entity 24 could permit an automotive OEM customer 22 to view a number of widgets produced, but not permit the customer 22 to see detailed financial data, such as profit margins, net sales, etc.

As additional example, assume that Boeing and Lockheed Martin are both registered customers 22 in the system 20, and that Acme Aviation is a registered entity 24 that does business with Boeing but does not do business with Lockheed. Acme could permit Boeing (Acme's client) to view Acme's scorecard and Acme's detailed financial data, but only permit Lockheed (a potential client) to only see Acme's scorecard 50 and not Acme's detailed financial data.

Marketing

The system 20 can also provide an opportunity for entities 24 to market their products or services and to generally network with other entities 24, customers 22, and non-subscribing users 30.

For example, assume that a non-subscribing user 30 wanted to obtain information about a particular industry, such as exterminators. The non-subscribing user 30 could be granted free access to an ad-supported version of the system 20, so that the non-subscribing user 30 could view limited performance data about a plurality of entities 24 in an exterminator segment while viewing banner ads from at least one entity 24 within that exterminator segment (or within an other segment).

As another example, assume that an entity 24 provides inventory reduction solutions to manufacturing businesses. The inventory reduction entity 24 could provide an ad to target a specific segment of entities 24, such as entities 24 in the Midwest whose inventory has a turnover is greater than 30 days and a value above $500,000. In this example, the ad could be presented to entities 24 on an entity homepage of every entity 24 in the specific segment.

In one example the service provider 28 may suggest targeted marketing opportunities to entities 24, such as helping marketing entities 24 to define target groups for their goods or services.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. A computer-implemented method of evaluating performance data, comprising:
assigning a weight to each of a plurality of key performance indicators (“KPIs”), each KPI having an associated bin, such that each KPI score corresponds to a predefined portion of a score for its associated bin;
assigning a weight to each bin, each bin corresponding to a scorecard, such that each bin score corresponds to a predefined portion of an overall score for the scorecard;
comparing received performance data to each KPI in at least one selected bin to determine a score for each KPI in the at least one selected bin;
dynamically calculating on a server an overall score in response to the at least one selected bin, in response to the assigned weight of the at least one selected bin and the assigned weights of its corresponding KPIs, and in response to the scores for the selection of KPIs; and
transmitting a scorecard to a user, the score card including at least the overall score.

2. The method of claim 1, further comprising:
creating a segment in response to the at least one selected bin and a selection of entities; and
filtering the performance data in response to the segment such that the transmitted scorecard illustrates the performance data for the KPIs in the at least one selected bin for the selection of entities.

3. The method of claim 2, wherein said transmitting a scorecard to a user, the score card including at least the overall score includes:
transmitting a description of the selection of entities;
transmitting a description of the at least one selected bin and its associated KPIs;
transmitting a scores for a plurality of KPIs for the plurality of related entities; and
transmitting at least one graph comparing the scores for the selection of entities.

4. The method of claim 1, further comprising:
receiving a registration for at least one entity through one of receiving a walkup registration from the at least one entity, receiving an invitation acceptance from the at least one entity, or receiving a manual registration from a secondary entity related to the at least one entity;
receiving performance data from the at least one entity; and
storing the performance data in a database on the server.

5. The method of claim 4, wherein said receiving a walkup registration includes:
initiating an entity registration in response to an entity request;
receiving an entity acceptance of a license agreement;
receiving a proposed entity name;
validating the proposed entity name to ensure that the entity name is unique; and
creating an entity profile using the proposed entity name.

6. The method of claim 1, wherein the performance data is received from a plurality of entities and wherein said transmitting a scorecard to a user, the score card including at least the overall score includes:
ranking a selected one of the plurality of entities in relation to the other plurality of entities; and
transmitting the ranking to the user.

7. The method of claim 1, wherein the user is a customer, the method further comprising:
A) transmitting a token to one of a customer or an entity;
B) receiving an acceptance of the token from the other of the customer or the entity; and
C) associating the entity with the customer in response to steps (A) and (B) such that the customer can view performance data submitted by the entity and can view KPI scores related to the performance data submitted by the entity.

8. The method of claim 1, further comprising:
looking up a permission level of the user in a database;
determining a set of performance data and KPI scores included in the permission level; and
preventing the user from accessing scores and performance data excluded from the permission level.

9. The method of claim 1, further comprising
defining a master template having access to each of a plurality of bins of KPIs, each of the plurality of bins having an assigned weight of an overall score, and each KPI having an assigned weight of the overall score;
defining a role having access to a selection of KPIs;
dynamically reweighting a weight assigned to the selection of KPIs in response to KPIs being excluded from the selection of KPIs.

10. A computer-implemented performance monitoring system, comprising:
an input/output module operable to receive performance data from at least one entity;
a storage module operable to store the performance data, and operable to store a plurality of key performance indicators (“KPIs”), each KPI having an associated bin and having a weight corresponding to a portion of a bin score, each bin having a weight corresponding to a portion of an overall score;
a central processing unit operable to process the performance data and compare the performance data to at least one KPI to determine a KPI score, a bin score, and an overall score in response to a bin selection and an entity selection; and
a scorecard illustrating scores for the selected bins of KPIs comparing the scores for each entity in the entity selection.

11. The performance monitoring system of claim 10, the scorecard further illustrating at least one graph comparing the scores for each entity in the entity selection.

12. The performance monitoring system of claim 10, the storage module being operable to store a permission level of each user of the system, the scorecard being transmitted to a user and the scorecard excluding performance data outside the permission level of the user.

13. The system of claim 10, wherein the bins of KPIs included in the scorecard are organized into a scorecard bin.

14. The performance monitoring system of claim 13, the central processing unit being operable to dynamically reweight at least one of the bin weights and the KPI weights in response to KPIs being excluded from the scorecard bin.
